(19) United States
(12) Patent Application Publication
(10) Pub. No.: US 2010/0099789 A1
(43) Pub. Date: Apr. 22, 2010

(54) METHOD FOR MODULATING LIGHT OF PHOTOREFRACTIVE COMPOSITION

(75) Inventors: Tao Gu, San Diego, CA (US); Peng Wang, San Diego, CA (US); Weiping Lin, Carlsbad, CA (US); Donald Flores, San Diego, CA (US); Michiharu Yamamoto, Carlsbad, CA (US)

Correspondence Address: KNOBBE MARTENS OLSON & BEAR LLP, 2040 MAIN STREET, FOURTEENTH FLOOR, IRVINE, CA, 92614, US

(73) Assignee: Nitto Denko Corporation, Osaka (JP)

(21) Appl. No.: 12/562,506

(22) Filed: Sep. 18, 2009

Related U.S. Application Data
(60) Provisional application No. 61/106,760, filed on Oct. 20, 2008.

(51) Int. Cl. C08F 2/46

(52) U.S. Cl. 522/53; 522/167; 522/173

(57) ABSTRACT

A method for forming a grating in a photorefractive composition comprising the steps of: providing a photorefractive composition containing a sensitizer and a polymer, wherein the polymer includes a first repeating unit which includes a moiety selected from the group consisting of the formulae (Ia), (Ib) and (Ic) as defined herein; and irradiating the photorefractive composition with a near infrared (NIR) laser, wherein the composition provides long grating holding time and the grating signal can be read out without external bias voltage.

### CROSS-REFERENCE TO RELATED APPLICATIONS

This application claims priority to U.S. Provisional Application Ser. No. 61/106,760 filed on Oct. 20, 2008, entitled “METHOD FOR MODULATING LIGHT OF PHOTOREFRACTIVE COMPOSITION,” the contents of which are hereby incorporated by reference in their entirety.

### BACKGROUND OF THE INVENTION

1. Field of the Invention

The invention relates to a method for modulating light using a photorefractive composition comprising a sensitizer and a polymer that is configured to be photorefractive upon irradiation by a near infrared (NIR) laser. Preferred photorefractive compositions provide long grating holding times and a grating signal can be read out without applying external bias voltage. More particularly, the polymer comprises at least one repeating unit that includes a moiety selected from the group consisting of a carbazole moiety, a tetraphenyl diaminobiphenyl moiety, and a triphenylamine moiety. Additionally, the composition can be configured to be photorefractive upon irradiation by incorporating a NIR laser-sensitive sensitizer. Furthermore, the invention relates to an optical device comprising the photorefractive composition that is irradiated by a NIR laser. Preferred compositions can be used for optical communication, optical switching materials, or medical imaging and devices.

2. Description of the Related Art

Photorefractivity is a phenomenon in which the refractive index of a material can be altered by changing the electric field within the material, such as by laser beam irradiation. The change of the refractive index typically involves: (1) charge generation by laser irradiation, (2) charge transport, resulting in the separation of positive and negative charges, (3) trapping of one type of charge (charge delocalization), (4) formation of a non-uniform internal electric field (space-charge field) as a result of charge delocalization, and (5) a refractive index change induced by the non-uniform electric field. Good photorefractive properties are typically observed in materials that combine good charge generation, charge transport or photoconductivity and electro-optical activity. Photorefractive materials have many promising applications, such as high-density optical data storage, dynamic holography, optical image processing, phase conjugated mirrors, optical computing, parallel optical logic, and pattern recognition. Particularly, long lasting grating behavior can contribute significantly for high-density optical data storage or holographic display applications.

Originally, the photorefractive effect was found in a variety of inorganic electro-optical crystals, such as LiNbO₃. In these materials, the mechanism of a refractive index modulation by the internal space-charge field is based on a linear electro-optical effect.

In 1990 and 1991, the first organic photorefractive crystal and polymeric photorefractive materials were discovered and reported. Such materials are disclosed, for example, in U.S. Pat. No. 5,064,264, the contents of which are hereby incorporated by reference in their entirety. Organic photorefractive materials offer many advantages over the original inorganic photorefractive crystals, such as large optical nonlinearities, low dielectric constants, low cost, lightweight, structural flexibility, and ease of device fabrication. Other important characteristics that may be desirable depending on the application include sufficiently long shelf life, optical quality, and thermal stability. These kinds of active organic polymers are emerging as key materials for advanced information and telecommunication technology.

In recent years, efforts have been made to improve the properties of organic, and particularly polymeric, photorefractive materials. Various studies have been done to examine the selection and combination of the components that give rise to each of these features. The photoconductive capability is frequently provided by incorporating materials containing carbazole groups. Phenyl amine groups can also be used for the charge transport part of the material.

The photorefractive composition may be made by mixing molecular components that provide desirable individual properties into a host polymer matrix. However, most of previously prepared compositions generally are sensitive to visible light such as green and red laser. U.S. Patent App. Pub. No. 2008/0039603 and U.S. Pat. No. 6,653,421, the contents of which are both hereby incorporated by reference in their entirety, disclose (meth)acrylate-based polymers and copolymer based materials which are sensitive to green laser and red laser, respectively.

For a variety of holographic applications, such as optical communication and medical imaging, infrared sensitivity is required. Efforts have been made, therefore, to provide compositions which are sensitive to infrared (IR) or near infrared (NIR) region. IR (typically 800 to 1550 nm) sensitization of several photorefractive polymers has been previously demonstrated in Mecher et al., Nature London, 418, 959 (2002); Eralp et al., J. Thomas Appl. Phys. Lett., 85, 1095 (2004); Tay et al., Appl. Phys. Lett., 85, 4561 (2004); and Tay et al., Appl. Phys. Lett., 87, 171105 (2005). However, none of the materials described above have achieved the desired combination of high diffraction efficiency along with long grating holding. A material with long grating holding possesses the ability to exhibit grating signal behavior for hours, even days after irradiation. Optical devices with these properties are useful for various applications, including data or image storage. Thus, there remains a need for optical devices comprising materials that combine good photorefractivity performances with long grating holding.

### SUMMARY OF THE INVENTION

Embodiments of the photorefractive compositions described herein can be configured to be photorefractive upon irradiation with a NIR laser. Grating signals can be held for hours, days, or longer, even for several years at a zero bias voltage for holographic applications in preferred compositions and methods described herein. Embodiments of the organic based compositions and holographic medium devices exhibit good diffraction efficiencies to NIR lasers. While the grating signals can be held for a long period of time, they can also optionally be erased by heating the photorefractive composition to remove a stored image. Erasing a previously written grating signal allows a user to rewrite another image into the composition. The availability of NIR-sensitive compositions that are sensitive to NIR continuous wave laser systems can be greatly advantageous and useful for various industrial applications, such as holographic applications, including optical communication and medical imaging.

An embodiment of this invention provides a method of forming a grating in a photorefractive composition, comprising the steps of providing a photorefractive composition responsive to a NIR laser, wherein the photorefractive composition comprises a sensitizer and a hole-transfer type polymer that exhibits good phase stability. In an embodiment, the method comprises irradiating the photorefractive composition with a NIR laser to form a grating, wherein the composition is formulated to provide grating holding time of about one hour or more upon irradiation by the NIR laser. In an embodiment, the grating signal is read without external bias voltage. In an embodiment, the polymer comprises at least one repeating unit that includes a moiety selected from the group consisting of a carbazole moiety, a tetraphenyl diaminobiphenyl moiety, and a triphenylamine moiety. In some embodiments, the composition can be used for holographic applications, such as optical communication and medical imaging materials, and in optical devices.

An embodiment provides a method of forming a grating in a photorefractive composition, comprising the steps of providing a photorefractive composition comprising a sensitizer and a polymer, wherein the polymer comprises a first repeating unit which includes a moiety selected from the group consisting of the following formulae (Ia), (Ib) and (Ic):

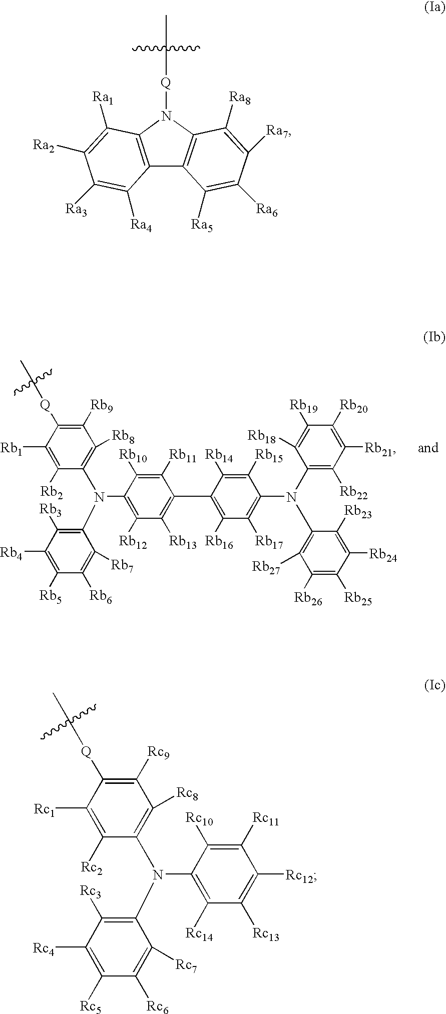

wherein each Q in formulae (Ia), (Ib) and (Ic) independently represents an alkylene or a heteroalkylene; Ra₁-Ra₈, Rb₁-Rb₂₇, and Rc₁-Rc₁₄ in formulae (Ia), (Ib), and (Ic) are each independently selected from the group consisting of hydrogen, linear or branched optionally substituted C₁-C₁₀ alkyl or heteroalkyl, and optionally substituted C₆-C₁₀ aryl; and irradiating the photorefractive composition with a NIR laser, thereby modulating light. In an embodiment, the irradiated composition provides a long grating holding time after irradiation with the NIR laser. For example, the grating holding time of the irradiated composition can be one hour or more.

Another embodiment provides a composition configured to be photorefractive upon irradiation by a NIR laser comprising a sensitizer and a polymer, wherein the polymer comprises a first repeating unit which includes at least one moiety selected from the group consisting of the formulae (Ia), (Ib) and (Ic), as defined above, along with substituents as defined above, wherein the composition provides a long grating holding time, e.g., about one hour or more, upon irradiation by a NIR laser. In an embodiment, the photorefractive composition is formulated such that a grating that is irradiated into the photorefractive composition can be read out of the photorefractive composition without applying an external bias voltage.

### DETAILED DESCRIPTION OF THE PREFERRED EMBODIMENT

While some photorefractive compositions can respond favorably to irradiation by laser light at visible wavelength (including red wavelength at about 633 nm and green wavelength at about 532 nm), their chemical and optical properties are generally incompatible with the absorbance of a NIR laser. In an embodiment, the compositions of the present invention exhibit photorefractive behavior when irradiated by a NIR laser. Some embodiments provide a method for modulating light using a photorefractive composition comprising a sensitizer and a polymer that is configured to be photorefractive upon irradiation by a near infrared laser. Preferably, the sensitizer in the composition is sensitive to a NIR laser.

Preferred irradiated compositions provide long grating holding times, and the grating signal can be read out of the photorefractive composition with little or no external bias voltage being applied. In an embodiment, the photorefractive composition may further comprise an ingredient that provides additional functionality, such as a chromophore and/or a plasticizer. In some embodiments, the ingredient that provides additional functionality can be attached to the polymer backbone in side chains. In some embodiments, the ingredient that provides additional non-linear optical functionality can be incorporated into the photorefractive composition as a stand-alone compound.

In an embodiment, the method of forming a grating in a photorefractive composition comprises providing a photorefractive composition responsive to irradiation by a NIR laser. In an embodiment, the laser is a NIR continuous wave laser. The composition comprising a sensitizer and a polymer exhibits photorefractive behavior upon irradiation by a NIR laser. In an embodiment, the polymer comprises a repeating unit that includes at least one moiety selected from the group consisting of the carbazole moiety (represented by formula (Ia)), tetraphenyl diaminobiphenyl moiety (represented by the formula (Ib)), and triphenylamine moiety (represented by the formula (Ic)).

Each of the alkyl, heteroalkyl, or aryl groups in formulae (Ia), (Ib), and (Ic) can be “optionally substituted” with one or more substituent group(s). When substituted, the substituent group(s) is(are) one or more group(s) individually and independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, alkylthio, arylthio, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, silyl ether, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof. Non-limiting examples of the substituent group(s) include methyl, ethyl, propyl, butyl, pentyl, isopropyl, methoxide, ethoxide, propoxide, isopropoxide, butoxide, pentoxide and phenyl.

The alkylene or heteroalkylene groups represented by Q in the various formulae described herein, including formulae (Ia), (Ib) and (Ic), can comprise from 1 to about 20 carbon atoms. In an embodiment, Q in formulae (Ia), (Ib) and (Ic) is selected from the group consisting of ethylene, propylene, butylene, pentylene, hexylene, and heptylene, each of which may optionally contain a heteroatom, such as O, N, or S. The heteroalkylene group can comprise one or more heteroatoms. Any heteroatom or combination of heteroatoms can be used, including O, N, S, and any combination thereof.

In some embodiments, the polymer comprising a first repeating unit that includes at least one of formulae (Ia), (Ib), and (Ic) may be polymerized or copolymerized to form a charge transport component of a photorefractive composition. In some embodiments, for example, a polymer comprising a first repeating unit that includes only one of the moieties alone may be polymerized to form a photorefractive polymer. In some embodiments, for example, two or more of the moieties may also be present in a copolymer to form a photorefractive polymer. The polymer or copolymer that includes one, two, or even three of these moieties possesses the charge transport ability.

Each of the moieties of formulae (Ia), (Ib), and (Ic) can be attached to a polymer backbone. Many polymer backbones including, but not limited to polyurethane, epoxy polymers, polystyrene, polyether, polyester, polyamide, polyimide, polysiloxane, and polyacrylate, with the appropriate side chains attached, can be used to make the polymers of the photorefractive composition. Some embodiments contain backbone units based on acrylates or styrene, and some of preferred backbone units are formed from acrylate-based monomers, and some are formed from methacrylate monomers. It is believed that the first polymeric materials to include photoconductive functionality in the polymer itself were the polyvinyl carbazole materials developed at the University of Arizona. However, these polyvinyl carbazole polymers tend to become viscous when subjected to some of the heat-processing methods used to form the polymer into films or other shapes for use in photorefractive devices.

The (meth)acrylate-based and acrylate-based polymers used in embodiments described herein have improved thermal and mechanical properties. Embodiments of the polymers described herein provide good durability and workability during processing by injection-molding or extrusion, especially when the polymers are prepared by radical polymerization. Some embodiments provide a composition comprising a sensitizer and a photorefractive polymer that is activated upon irradiation by a NIR laser, wherein the photorefractive polymer comprises a repeating unit selected from the group consisting of the following formulae:

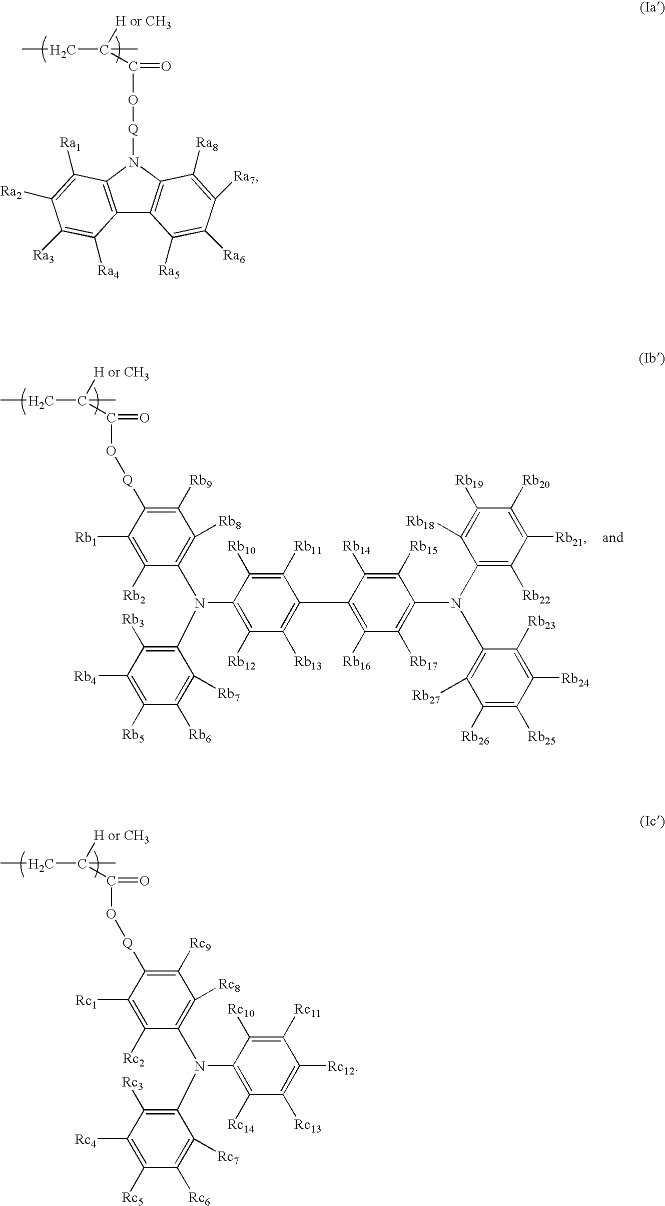

In an embodiment, each Q in formulae (Ia′), (Ib′) and (Ic′) independently represents an alkylene group or a heteroalkylene group. In an embodiment, Ra₁-Ra₈, Rb₁-Rb₂₇ and Rc₁-Rc₁₄ in formulae (Ia′), (Ib′) and (Ic′) are each independently selected from the group consisting of hydrogen, linear or branched optionally substituted C₁-C₁₀ alkyl or heteroalkyl, and optionally substituted C₆-C₁₀ aryl. The heteroatom in the heteroalkylene group or the heteroalkyl group can have one or more heteroatoms selected from S, N, or O.

In some embodiments, a polymer comprising at least one repeating unit that includes a moiety of at least one of formulae (Ia′), (Ib′) and (Ic′) can also be polymerized or copolymerized to form a photorefractive polymer that provides charge transport ability. In some embodiments, monomers comprising a phenyl amine derivative can be copolymerized to form the charge transport component as well. Non-limiting examples of such monomers are carbazolylpropyl(meth)acrylate monomer; 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. These monomers can be used to form polymer by themselves or to form copolymers, e.g., by polymerization of a mixture of two or more monomers.

In preferred embodiments the photorefractive composition described herein can be configured to be photorefractive upon irradiation with a NIR laser by incorporation of an appropriate sensitizer. The sensitizer can be added into the composition as a mixture with the polymer and/or be directly bonded to the polymer, e.g., by covalent or other bonding. In an embodiment, the sensitizer comprises a molecule according to formula (V):

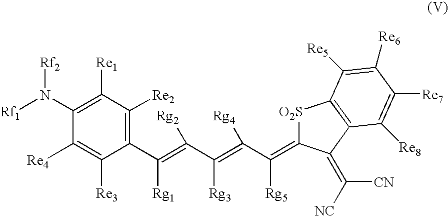

wherein Re₁-Re₈ and Rg₁-Rg₅ in formula (V) are each independently selected from the group consisting of hydrogen, linear or branched C₁-C₁₀ alkyl or heteroalkyl, C₆-C₁₀ aryl, and halogen. In an embodiment, Rf₁ and Rf₂ in formula (V) are each independently selected from the group consisting of hydrogen, linear or branched optionally substituted C₁-C₁₀ alkyl. If the sensitizer according to formula (V) is directly bonded to the polymer, the site of the covalent bond can be at any of the Re₁-Re₈, Rf₁, Rf₂, or Rg₁-Rg₅ locations.

Preferably, Re₁-Re₈ and Rg₁-Rg₅ are each independently selected from the group consisting of hydrogen and linear or branched C₁-C₄ alkyl or heteroalkyl; and Rf₁ and Rf₂ are each independently selected from the group of linear or branched C₁-C₁₀ alkyl, CH₂CH₂OH, CH₂CH₂OCOCH₃, and CH₂CH₂OSi(CH₃)₂C(CH₃)₃. In an embodiment, the sensitizer comprises 2-[2-{5-[4-(di-n-butylamino)phenyl]-2,4-pentadienylidene-1,1-dioxido-1-benzothien-3 (2H)-ylidene]malononitrile:

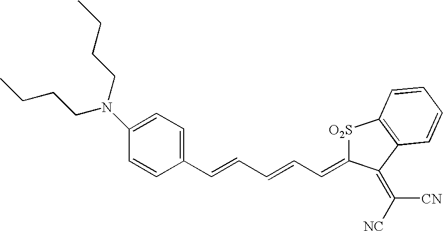

The amount of sensitizer in the photorefractive composition can vary. Typically, sufficient sensitizer is included to provide responsiveness to NIR irradiation, while not being so great in amount so as to decrease transmittance of the composition. For example, it is often desirable that the photorefractive composition have a transmittance of at least about 30%. Also, addition of too much sensitizer may provide a composition that is prone to phase separation. In an embodiment, sensitizer is provided in the composition in an amount in the range of about 0.01% to about 10% based on the weight of the composition. In an embodiment, sensitizer is provided in the composition in an amount in the range of about 0.1% to about 10% based on the weight of the composition. In an embodiment, sensitizer is provided in the composition in an amount in the range of about 0.1% to about 7% based on the weight of the composition. In an embodiment, sensitizer is provided in the composition in an amount in the range of about 0.1% to about 5% based on the weight of the composition. In an embodiment, sensitizer is provided in the composition in an amount in the range of about 0.5% to about 5% based on the weight of the composition. In an embodiment, sensitizer is provided in the composition in an amount in the range of about 1% to about 5% based on the weight of the composition.

In some embodiments, the photorefractive composition further comprises another component that has non-linear optical functionality. Moieties or chromophores with non-linear optical functionality may be incorporated into the polymer matrix as an additive to the composition or as side chains attached to monomers to be copolymerized. Moieties or chromophores can be any group known in the art to provide non-linear optical capability. Addition of chromophore to the composition can change the refractive index of the composition induced by a non-uniform electrical field.

In an embodiment, other non-linear optical moieties can be incorporated into the composition. In some embodiments, the photorefractive composition comprises additional repeating units having one or more non-linear optical moiety. In some embodiments, the non-linear optical moiety may be presented as a group attached to a monomer that allows copolymerization to form polymers with charge transport moieties. In some embodiments, the photorefractive polymer further comprises a second repeating unit represented by the following formula:

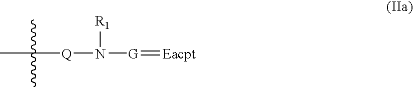

wherein Q in formula (IIa) represents an alkylene group or a heteroalkylene group, the heteroalkylene group has one or more heteroatoms selected from S, N, or O; R₁ in formula (IIa) is selected from the group consisting of hydrogen, linear or branched C₁-C₁₀ alkyl, and C₆-C₁₀ aryl; G in formula (IIa) is a π-conjugated group; and Eacpt in formula (IIa) is an electron acceptor group. In some embodiments, R₁ in formula (IIa) is an alkyl group selected from methyl, ethyl, propyl, butyl, pentyl, and hexyl. In some embodiments, Q in formula (IIa) is an alkylene group represented by (CH₂)ₚ where p is in the range of about 2 to about 10. In some embodiments, Q in formula (IIa) is selected from the group consisting of ethylene, propylene, butylene, pentylene, hexylene, and heptylene.

In some embodiments, the photorefractive polymer comprises a second repeating unit represented by the following formula:

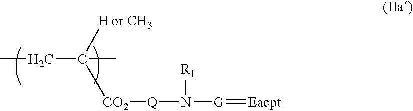

wherein Q in formula (IIa′) represents an alkylene group or a heteroalkylene group, the heteroalkylene group has one or more heteroatom such as S, N, or O; R₁ in formula (IIa′) is selected from the group consisting of hydrogen, linear or branched C₁-C₁₀ alkyl, and C₆-C₁₀ aryl; G in formula (IIa′) is a π-conjugated group and Eacpt in formula (IIa′) is an electron acceptor group. In some embodiments, R₁ in formula (IIa′) is an alkyl group selected from methyl, ethyl, propyl, butyl, pentyl and hexyl. In some embodiments, Q in formula (IIa′) is an alkylene group represented by (CH₂)ₚ where p is in the range of about 2 to about 10. In some embodiments, Q in formula (IIa′) is selected from the group consisting of ethylene, propylene, butylene, pentylene, hexylene, and heptylene.

The term “π-conjugated group” refers to a molecular fragment that contains π-conjugated bonds. The π-conjugated bonds refer to covalent bonds between three or more atoms that have σ bonds and π bonds formed between two atoms by overlapping of atomic orbits (s+p hybrid atomic orbits for σ bonds and p atomic orbits for π bonds). In some embodiments, G in formulae (IIa) and (IIa′) is independently represented by a formula selected from the following:

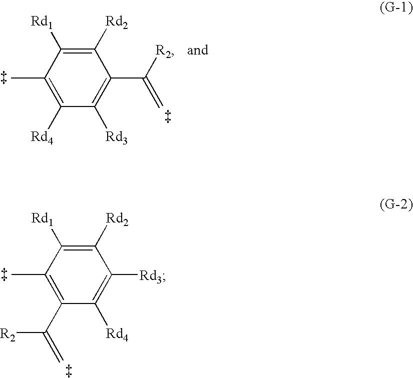

wherein Rd₁-Rd₄ in formulae (G-1) and (G-2) are each independently selected from the group consisting of hydrogen, linear or branched C₁-C₁₀ alkyl, C₆-C₁₀ aryl, and halogen, and R₂ in formulae (G-1) and (G-2) is independently selected from the group consisting of hydrogen, linear or branched C₁-C₁₀ alkyl, and C₆-C₁₀ aryl.

The term “electron acceptor group” refers to a group of atoms with a high electron affinity that can be bonded to a π-conjugated group. Exemplary acceptors, in order of increasing strength, are: C(O)NR²<C(O)NHR<C(O)NH₂<C(O)OR<C(O)OH<C(O)R<C(O)H<CN<S(O)₂R<NO₂, wherein each R in these electron acceptors may independently be, for example, hydrogen, linear or branched C₁-C₁₀ alkyl, or C₆-C₁₀ aryl. As shown in U.S. Pat. No. 6,267,913, examples of electron acceptor groups include:

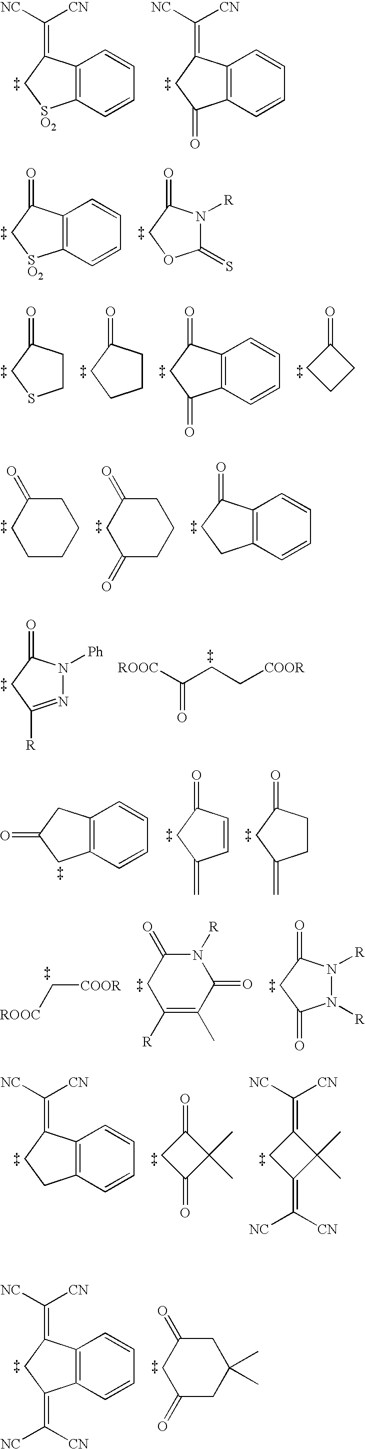

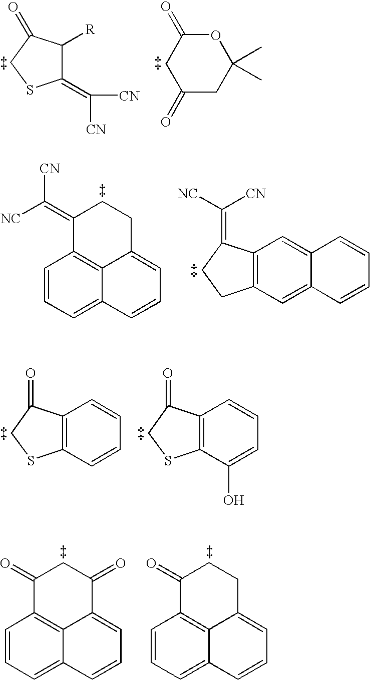

wherein R in each of the above compounds is independently selected from the group consisting of hydrogen, linear or branched C₁-C₁₀ alkyl, and C₆-C₁₀ aryl. The symbol “‡” in a chemical structure specifies an atom of attachment to another chemical group and indicates that the structure is missing a hydrogen that would normally be implied by the structure in the absence of the “‡”.

In some embodiments, Eacpt in formulae (IIa) and (IIa′) may independently be oxygen or represented by a formula selected from the group consisting of the following:

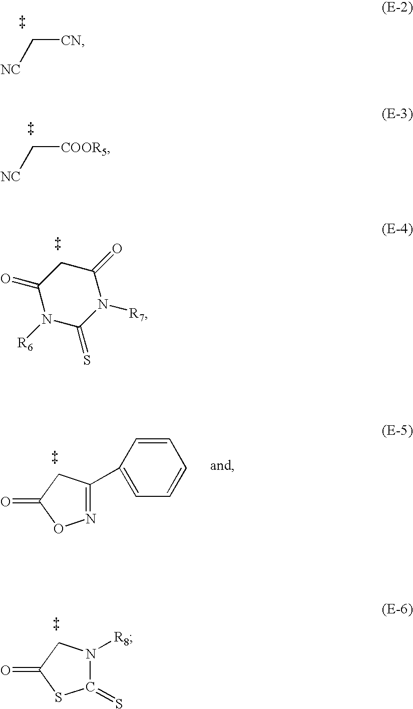

wherein R₅, R₆, R₇ and R₈ in the above formulae are each independently selected from the group consisting of hydrogen, linear or branched C₁-C₁₀ alkyl, and C₆-C₁₀ aryl.

To prepare the non-linear optical component-containing copolymer, monomers that have side-chain groups possessing non-linear-optical ability may be used. Non-limiting examples of such monomers include:

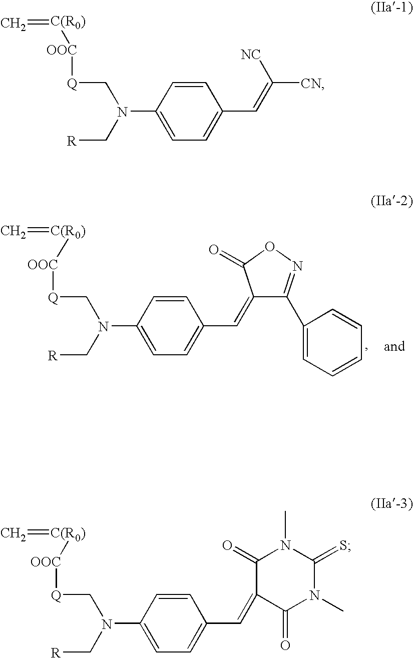

wherein each Q in the monomers above independently represent an alkylene group or a heteroalkylene group, the heteroalkylene group has one or more heteroatoms such as O, N, or S; each R₀ in the monomers above is independently selected from hydrogen or methyl; and each R in the monomers above is independently selected from linear or branched C₃-C₁₀ alkyl. In some embodiments, Q in the monomers above may be an alkylene group represented by (CH₂)ₚ where p is in the range of about 2 to about 6. In some embodiments, each R in the monomers above may be independently selected from the group consisting of methyl, ethyl and propyl.

In some embodiments, monomers comprising a chromophore, can also be used to prepare the non-linear optical component-containing polymer. Non-limiting examples of monomers including a chromophore group as the non-linear optical component include N-ethyl, N-4-dicyanomethylidenyl acrylate and N-ethyl, N-4-dicyanomethylidenyl-3,4,5,6,10-pentahydronaphtylpentyl acrylate. Alternatively, or additionally, the chromophore can be added to the composition as a separate ingredient that is not copolymerized with the charge-transport monomers.

The amount of chromophore in the photorefractive composition can vary. Preferably, the chromophore is provided in an amount that is sufficient to change the refractive index of the composition. In an embodiment, the chromophore provides a non-linear optical property to the composition such that, after irradiation of the composition, photorefractive grating signals can be detected. However, phase separation can result if too much chromophore is added into the composition. In an embodiment, chromophore is provided in the composition in an amount in the range of about 0.1% to about 70% based on the weight of the composition. In an embodiment, chromophore is provided in the composition in an amount in the range of about 5% to about 60% based on the weight of the composition. In an embodiment, chromophore is provided in the composition in an amount in the range of about 10% to about 50% based on the weight of the composition. In an embodiment, chromophore is provided in the composition in an amount in the range of about 20% to about 40% based on the weight of the composition.

The polymers described herein may be prepared in various ways known in the art, e.g., by polymerization of the corresponding monomers or precursors thereof. Polymerization may be carried out by methods known to a skilled artisan, as informed by the guidance provided herein. In some embodiments, radical polymerization using an azo-type initiator, such as AIBN (azoisobutyl nitrile), may be carried out. The radical polymerization technique makes it possible to prepare random or block copolymers comprising both charge transport and non-linear optical groups. Further, by following the techniques described herein, it is possible to prepare such materials with exceptionally good properties, such as photoconductivity and diffraction efficiency. In an embodiment of a radical polymerization method, the polymerization catalyst is generally used in an amount of from 0.01 to 5 mole % or from 0.1 to 1 mole % per mole of the total polymerizable monomers.

In some embodiments, radical polymerization can be carried out under inert gas (e.g., nitrogen, argon, or helium) and/or in the presence of a solvent (e.g., ethyl acetate, tetrahydrofuran, butyl acetate, toluene or xylene). Polymerization may be carried out under a pressure in the range of about 1 Kgf/cm² to about 50 Kgf/cm² or about 1 Kgf/cm² to about 5 Kgf/cm². In some embodiments, the concentration of total polymerizable monomer in a solvent may be about 0.99% to about 50% by weight, preferably about 2% to about 9.1% by weight. The polymerization may be carried out at a temperature in the range of about 50° C. to about 100° C., and may be allowed to continue for about 1 to about 100 hours, depending on the desired final molecular weight, polymerization temperature, and taking into account the polymerization rate.

Some embodiments provide a polymerization method involving the use of a precursor monomer with a functional group for non-linear optical ability for preparing the copolymers. The precursor may be represented by the following formula:

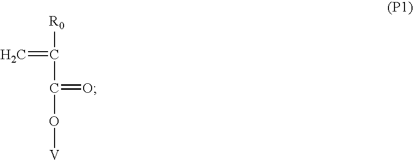

wherein R₀ in (P1) is hydrogen or methyl, and V in (P1) is a group selected from the formulae (V-1) and (V-2):

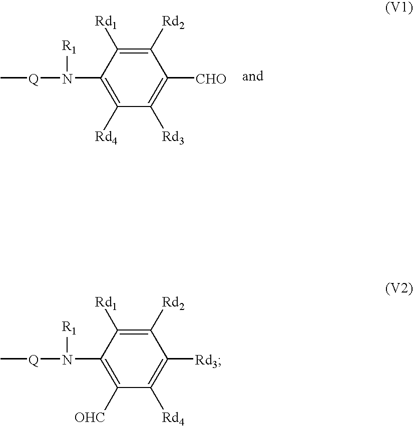

wherein each Q in (V1) and (V2) independently represents an alkylene group or a heteroalkylene group, the heteroalkylene group has one or more heteroatoms such as O, N, and S; Rd₁-Rd₄ in (V1) and (V2) are each independently selected from the group consisting of hydrogen, linear or branched C₁-C₁₀ alkyl, and C₆-C₁₀ aryl, and R₁ in (V1) and (V2) is C₁-C₁₀ alkyl (branched or linear). In some embodiments, Q in (V1) and (V2) may independently be an alkylene group represented by (CH₂)ₚ where p is in the range of about 2 to about 6. In some embodiments, R₁ in (V1) and (V2) is independently selected from the group consisting of methyl, ethyl, propyl, butyl, pentyl and hexyl. In an embodiment, Rd₁-Rd₄ in (V1) and (V2) are hydrogen.

In some embodiments, polymerization of the precursor monomer can be carried out under conditions generally similar to those described above. After the precursor copolymer has been formed, it can be converted into the corresponding copolymer having non-linear optical groups and capabilities by a condensation reaction. In some embodiments, the condensation reagent may be selected from the group consisting of:

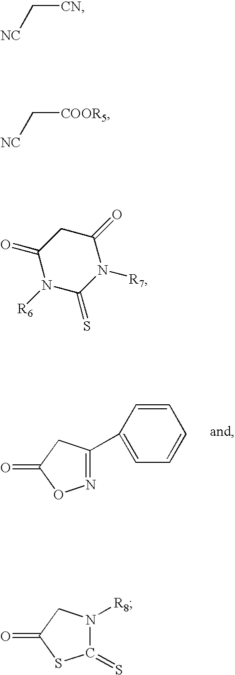

wherein R₅, R₆, R₇ and R₈ of the condensation reagents above are each independently selected from the group consisting of hydrogen, C₁-C₁₀ alkyl and C₆-C₁₀ aryl. The alkyl group may be either branched or linear.

In some embodiments, the condensation reaction between the precursor polymer and the condensation reagent can be carried out in the presence of a pyridine derivative catalyst at room temperature for about 1 to about 100 hrs. In some embodiments, a solvent, such as butyl acetate, chloroform, dichloromethane, toluene or xylene, can also be used. In some embodiments, the reaction may be carried out without the catalyst at a solvent reflux temperature of 30° C. or above for about 1 to about 100 hours.

Other chromophores that possess non-linear optical properties in a polymer matrix are described in U.S. Pat. No. 5,064,264 (incorporated herein by reference) and may also be used in some embodiments. Additional suitable materials known in the art may also be used, and are well described in the literature, such as D. S. Chemla & J. Zyss, “Nonlinear Optical Properties of Organic Molecules and Crystals” (Academic Press, 1987). U.S. Pat. No. 6,090,332 describes fused ring bridge and ring locked chromophores that can form thermally stable photorefractive compositions, which may be useful as well. The chosen compound(s) is sometimes mixed in the copolymer in a concentration of about 1% to about 50% by weight.

In some embodiments, the composition further comprises an ingredient that provides additional non-linear optical functionality. Chromophores can be any group known in the art to provide non-linear optical capability.

In some embodiments, the photorefractive composition further comprises a plasticizer. Any commercial plasticizer such as phthalate derivatives or low molecular weight hole transfer compounds (e.g., N-alkyl carbazole or triphenylamine derivatives or acetyl carbazole or triphenylamine derivatives) may be incorporated into the polymer matrix. An N-alkyl carbazole or triphenylamine derivative containing electron acceptor group is a suitable plasticizer that can help the photorefractive composition be more stable, as the plasticizer contains both N-alkyl carbazole or triphenylamine moiety and non-linear optical moiety in one compound.

Other non-limiting examples of the plasticizer include ethyl carbazole; 4-(N,N-diphenylamino)-phenylpropyl acetate; 4-(N,N-diphenylamino)-phenylmethyloxy acetate; N-(acetoxypropylphenyl)-N,N′,N′-triphenyl-(1,1′-biphenyl)-4,4′-diamine; N-(acetoxypropylphenyl)-N′-phenyl-N,N′-di(4-methyl-phenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more plasticizers. Also, un-polymerized monomers can be low molecular weight hole transfer compounds, for example 4-(N,N-diphenyl amino)-phenylpropyl(meth)acrylate; N-[(meth)acroyloxypropylphenyl]-N,N′, N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

In some embodiments, a plasticizer may be selected from N-alkyl carbazole or triphenylamine derivatives:

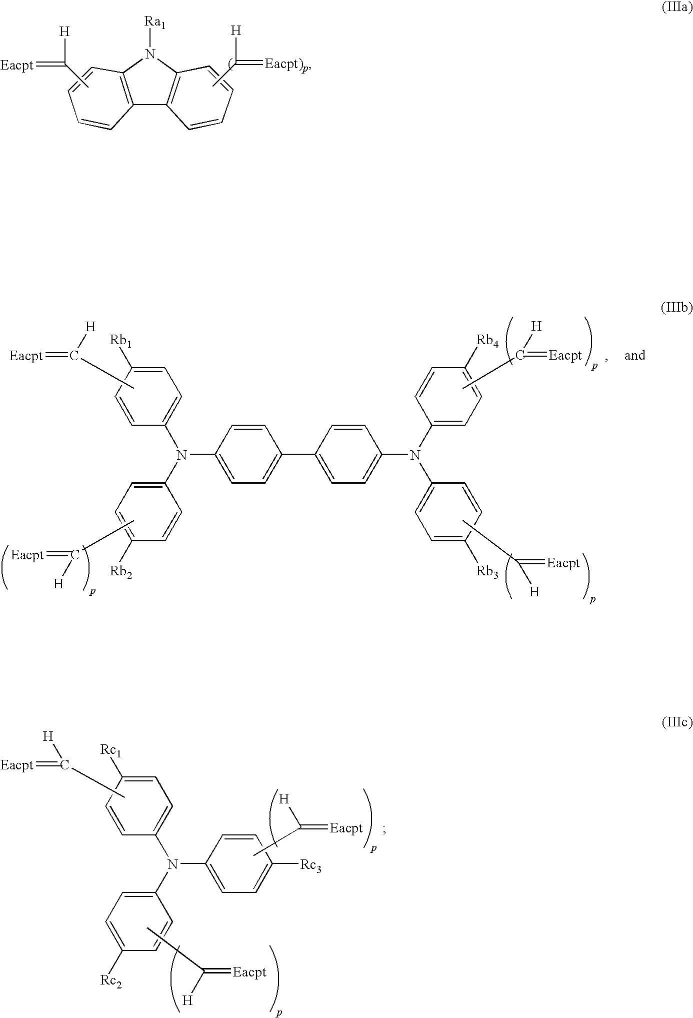

wherein Ra₁, Rb₁-Rb₄ and Rc₁-Rc₃ in Formulae (Ma), (IIIb), and (IIIc) are each independently selected from the group consisting of hydrogen, branched or linear C₁-C₁₀ alkyl, and C₆-C₁₀ aryl; each p is independently 0 or 1; Eacpt is an electron acceptor group and represented by oxygen or a structure selected from the group consisting of the structures;

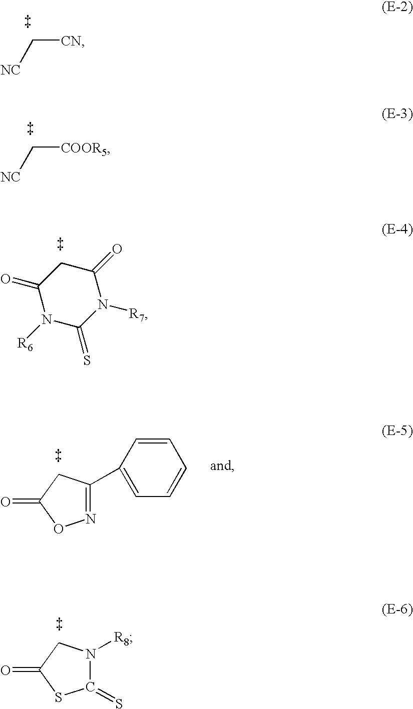

wherein R₅, R₆, R₇ and R₈ in formulae (E-3), (E-4) and (E-6) are each independently selected from the group consisting of hydrogen, linear or branched C₁-C₁₀ alkyl, and C₆-C₁₀ aryl.

In some embodiments, the photorefractive composition comprises a copolymer that provides photoconductive (charge transport) ability and non-linear optical ability. The photorefractive composition may also include other components as desired, such as plasticizer components. Some embodiments provide a photorefractive composition that comprises a copolymer. The copolymer may comprise a first repeating unit that includes a first moiety with charge transport ability, a second repeating unit including a second moiety with non-linear optical ability, and a third repeating unit that include a third moiety with plasticizing ability.

The ratio of different types of monomers used in forming the copolymer may be varied over a broad range. Some embodiments provide a photorefractive composition with the first repeating unit (e.g., the repeating unit with charge transport ability) to the second repeating unit (e.g., the repeating unit with non-linear optical ability) weight ratio of about 100:1 to about 0.5:1, preferably about 10:1 to about 1:1. When the weight ratio of the first repeating unit to the second repeating unit is smaller than 0.5:1, the charge transport ability of copolymer may be relatively weak to give good photorefractivity. However, even in this case, the addition of low molecular weight components having non-linear-optical ability, e.g., as described elsewhere herein, can enhance photorefractivity. If the weight ratio is larger than about 100:1, the non-linear optical ability of copolymer may be too weak, and the diffraction efficiency tends to be too low to give good photorefractivity. However, even in this case, the addition of low molecular weight components having charge transport ability, e.g., as described elsewhere herein, can enhance photorefractivity.

In some embodiments, the molecular weight and the glass transition temperature, Tg, of the copolymer are selected to provide desirable physical properties. In some embodiments, it is valuable and desirable, although not essential, that the polymer is capable of being formed into films, coatings and shaped bodies of various kinds by standard polymer processing techniques (e.g., solvent coating, injection molding or extrusion).

In some embodiments, the polymer has a weight average molecular weight, Mw, in the range of from about 3,000 to about 500,000, preferably in the range from about 5,000 to about 100,000. The term “weight average molecular weight” as used herein means the value determined by the GPC (gel permeation chromatography) method using polystyrene standards, as is well known in the art. In some embodiments, additional benefits may be provided by lowering the dependence on plasticizers. By selecting copolymers with intrinsically moderate Tg and by using methods that tend to depress the average Tg, it is possible to limit the amount of plasticizer in the composition to no more than about 30% or about 25%, and in some embodiments, no more than about 20%. In some embodiments, the photorefractive composition that can be activated by a NIR laser may have a thickness of about 105 μm and a transmittance of greater than about 30%. In an embodiment, the photorefractive composition has a transmittance of from about 40% to about 90% at a thickness of about 105 μm. If the photorefractive composition has a transmittance of greater than about 30% at a thickness of 105 μm when irradiated by a NIR laser, the NIR laser beam can smoothly pass through the composition to form grating image and signals.

An embodiment provides a photorefractive composition that becomes photorefractive upon irradiation by a NIR laser, wherein the photorefractive composition comprises a polymer comprising a first repeating unit that includes at least one moiety selected from the group consisting of the formulae (Ia), (Ib) and (Ic) as defined above. In some embodiments, the polymer may further comprise a second repeating unit comprising at least one moiety selected from formula (IIa) and chromophores. In some embodiments, the polymer may further comprise a repeating unit formula (IIa′). In some embodiments, the polymer may further comprise a third repeating unit that includes at least one moiety selected from formulae (IIIa), (IIIb) and (IIIc). In an embodiment, an optical device comprises any one of the photorefractive compositions described herein.

Another embodiment provides an optical device comprising a photorefractive composition responsive to a NIR laser, as described herein. Examples of optical devices that comprises the photorefractive composition include high-density optical data storage devices, dynamic holography devices, optical image processing devices, phase conjugated mirrors, optical computing devices, optical switching devices, parallel optical logic devices, pattern recognition devices, and medical imaging devices. The long lasting grating behavior exhibited in the compositions described herein can contribute significantly for high-density optical data storage or holographic display applications.

Many currently available photorefractive polymers have poor phase stabilities and can become hazy after days. Where the film composition comprising the photorefractive polymer shows significant haziness, poor photorefractive properties are typically exhibited. The haziness of the film composition usually results from incompatibilities between several photorefractive components. For example, photorefractive compositions containing both charge transport ability components and non-linear optical components may exhibit haziness because the components having charge transport ability are usually hydrophobic and non-polar, whereas components having non-linear optical ability are usually hydrophilic and polar. As a result, the natural tendency of the composition is to phase separate, thus causing haziness.

However, the preferred embodiments presented herein show good phase stability and gave no haziness, even after several months. Such compositions retain good photorefractive properties, as the compositions are very stable and exhibit little or no phase separation. Without being bound by theory, the stability is likely attributable to the sensitizer and/or a mixture of sensitizer with various chromophores. In addition, the matrix polymer system can be a copolymer of components having charge transport ability and components having non-linear optics ability. That is, the components having charge transport ability and the components having non-linear optical ability can coexist in one polymer chain, therefore rendering significant detrimental phase separation difficult and unlikely.

Furthermore, although heat usually increases the rate of phase separation, preferred compositions described herein exhibit good phase stability, even after being heated. In accelerated heat testing, test samples heated at about 40° C., about 60° C., about 80° C., and about 120° C. are found to be stable after days, weeks, and sometimes even after 6 months. The good phase stability allows the copolymer to be further processed and incorporated into optical device applications for various commercial products.

For preferred photorefractive devices, usually the thickness of a photorefractive layer is in the range of about 10 μm to about 200 μm. Preferably, the thickness range is in the range of about 30 μm to about 150 μm. In many cases, if the sample thickness is less than 10 μm, the diffracted signal is not the desired Bragg Refraction region, but Raman-Nathan Region which does not show proper grating behavior. On the other hand, if the sample thickness is greater than 200 μm, too high bias voltage is often required to show grating behavior. Also, composition transmittance for NIR laser beams can be reduced significantly and result in no grating signals at higher thicknesses.

The NIR wavelength that the photorefractive composition can transmit may vary. For example, the composition can transmit NIR laser wavelength between about 700 nm and about 1320 nm. In some embodiments, the composition is configured to transmit 980 nm wave length laser beam. The composition transmittance depends on the photorefractive layer thickness, thus by controlling the thickness of the photorefractive layer comprising a photorefractive composition, the light modulating characteristics can be adjusted as desired. When the transmittance is low, the NIR laser beam may not pass through the layer to form a grating image and signals. On the other hand, if the absorbance is 0%, no laser energy can be absorbed to generate grating signals. In some embodiments, the suitable range of transmittance is about 10% to about 99.99%, about 30% to about 99.9%, and about 40% to about 90%. Linear transmittance was performed to determine the absorption coefficient of the photorefractive device. For measurements, a photorefractive layer was exposed to a 980 nm laser beam with an incident path perpendicular to the layer surface. The beam intensity before and after passing through the photorefractive layer is monitored and the linear transmittance of the sample is given by:

T=I_{Transmitted}/I_{incident}

The wave length of NIR laser is not particularly limited. Typically, a NIR laser is defined as a laser which emits light wave-length of between 700 nm and 1320 nm. For example, a widely available 785 nm, 830 nm, 980 nm, or 1060 nm laser can be used as a NIR light source.

One of the various advantages of preferred photorefractive compositions described herein is a long grating holding time. Longer grating holding enables the photorefractive composition to be used for applications such as optical communication and medical imaging. In an embodiment, the grating holding time is one hour or more. In an embodiment, the grating holding time is four hours or more. In an embodiment, the grating holding time is one day or more. In an embodiment, the grating holding time is two days or more. In an embodiment, the grating holding time is one week or more. In an embodiment, the grating holding time is one month or more. In an embodiment, the grating holding time is six months or more. In an embodiment, the grating holding time is one year or more. In an embodiment, the grating holding time is several years. In an embodiment, the grating holding time is nearly permanent, e.g., ten years or longer.

Furthermore, in preferred embodiments, the grating having a long grating holding time can be written without using a very high electric field, such as a field in excess of about 70 V/μm (expressed as bias voltage). In some embodiments, a grating signal can generally be achieved at a bias voltage no higher than about 65 V/μm, including about 60 to about 30 μm, and about 50 to about 40 V/μm.

In some embodiments, the grating signal can be read out without external bias voltage. In some embodiments, the photorefractive compositions described herein demonstrate grating holding time from hours to days at 980 nm at a zero bias voltage. In some embodiments, the photorefractive compositions described herein demonstrate grating holding time from weeks to months at 980 nm at a zero bias voltage. In some embodiments, the photorefractive compositions described herein demonstrate grating holding time of several years at 980 nm at a zero bias voltage. In some embodiments, the photorefractive compositions described herein have demonstrated a nearly permanent grating holding at 980 nm at a zero bias voltage.

An additional advantage of the preferred photorefractive compositions is the high diffraction efficiency, η, that can be achieved. Diffraction efficiency is defined as the ratio of the intensity of a diffracted beam to the intensity of an incident probe beam, and is determined by measuring the intensities of the respective beams. A device is more effective, the closer the ratio is to 100%. In general, for a given photorefractive composition, a higher diffraction efficiency can be achieved by increasing the applied bias voltage. The samples of preferred embodiments described herein could provide as high as 50% of the diffraction efficiency.

The embodiments are now further described by the following examples, which are intended to be illustrative of the invention, but are not intended to limit the scope or underlying principles in any way.

### Example 1

### (a) Monomers Containing Charge Transport Groups

N-[acroyloxypropoxyphenyl]-N,N′,N′-triphenyl-(1,1′-biphenyl)-4,4′-diamine (TPD acrylate) monomer was purchased from Fuji Chemical, Japan, and has the following structure:

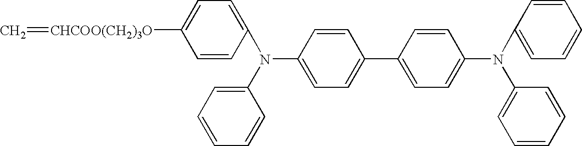

### (b) Monomers Containing Non-Linear Optical Groups

The non-linear optical precursor monomer 5-[N-ethyl-N-4-formylphenyl]amino-pentyl acrylate was synthesized according to the following synthesis scheme:

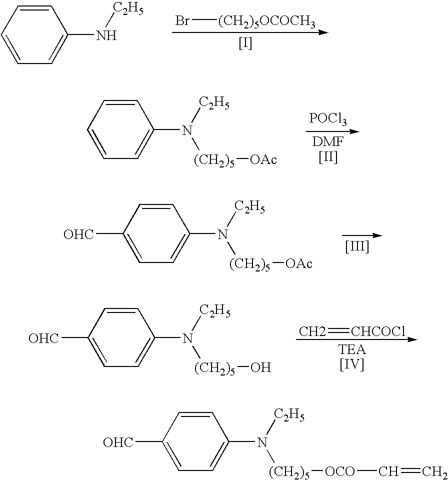

STEP I: Bromopentyl acetate (5 mL, 30 mmol), toluene (25 mL), triethylamine (4.2 mL, 30 mmol), and N-ethylaniline (4 mL, 30 mmol) were added together at room temperature. The mixture was heated at 120° C. overnight. After cooling down, the reaction mixture was rotary-evaporated to form a residue. The residue was purified by silica gel chromatography (developing solvent: hexane/acetone=9/1). An oily amine compound was obtained. (Yield: 6.0 g (80%)).

STEP II: Anhydrous DMF (6 mL, 77.5 mmol) was cooled in an ice-bath. Then, POCl₃ (2.3 mL, 24.5 mmol) was added dropwise into the cooled anhydrous DMF, and the mixture was allowed to come to room temperature. The amine compound (5.8 g, 23.3 mmol) was added through a rubber septum by syringe with dichloroethane. After stirring for 30 min., the reaction mixture was heated to 90° C. and the reaction was allowed to proceed overnight under an argon atmosphere. After the overnight reaction, the reaction mixture was cooled and poured into brine water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=3/1). An aldehyde compound was obtained. (Yield: 4.2 g (65%)).

STEP III: The aldehyde compound (3.92 g, 14.1 mmol) was dissolved in methanol (20 mL). Into the solution, potassium carbonate (400 mg) and water (1 mL) were added at room temperature and the solution was stirred overnight. Next, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=1/1). An aldehyde alcohol compound was obtained. (Yield: 3.2 g (96%)).

STEP IV: The aldehyde alcohol (5.8 g, 24.7 mmol) was dissolved in anhydrous THF (60 mL). Into the solution, triethylamine (3.8 mL, 27.1 mmol) was added and the solution was cooled by ice-bath. Acrolyl chloride (2.1 mL, 26.5 mmol) was added and the solution was maintained at 0° C. for 20 minutes. Thereafter, the solution was allowed to warm up to room temperature and stirred at room temperature for 1 hour, at which point TLC indicated that all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=1/1). The compound yield was 5.38 g (76%), and the compound purity was 99% (by GC).

### (c) Purification of Non-Linear Optical Chromophore NPP

NPP ((s)-(−)-1-(4-nitrophenyl)-2-pyrrolidinemethanol, 98%) is commercially available from Aldrich and used after recrystallization.

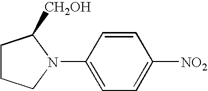

### (d) Synthesis of Non-Linear Optical Chromophore 7-FDCST

The non-linear optical precursor 7-FDCST (7 member ring dicyanostyrene, 4-homopiperidino-2-fluorobenzylidene malononitrile) was synthesized according to the following two-step synthesis scheme:

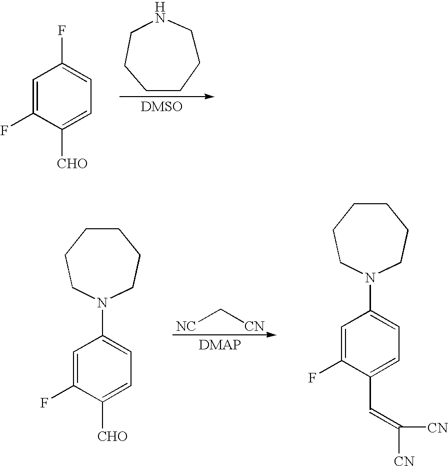

A mixture of 2,4-difluorobenzaldehyde (25 g, 176 mmol), homopiperidine (17.4 g, 176 mmol), lithium carbonate (65 g, 880 mmol), and DMSO (625 mL) was stirred at 50° C. for 16 hours. Water (50 mL) was added to the reaction mixture. The products were extracted with ether (100 mL). After removal of ether, the crude products were purified by silica gel column chromatography using hexanes-ethyl acetate (9:1) as eluent and crude intermediate was obtained (22.6 g). 4-(Dimethylamino)pyridine (230 mg) was added to a solution of the 4-homopiperidino-2-fluorobenzaldehyde (22.6 g, 102 mmol) and malononitrile (10.1 g, 153 mmol) in methanol (323 mL). The reaction mixture was kept at room temperature and the product was collected by filtration and purified by recrystallization from ethanol. The compound yield was 18.1 g (38%).

### (e) Synthesis of Sensitizer 2-[2-{5-[4-(di-n-butylamino)phenyl]-2,4-pentadienylidene}-1,1-dioxido-1-benzothien-3(2H)-ylidene]malononitrile (DBM)

The sensitizer DBM was synthesized according to the literature reference Chem. Eur. J. 1997, 3, 1091, the contents of which are hereby incorporated by reference in their entirety. The structure is given below.

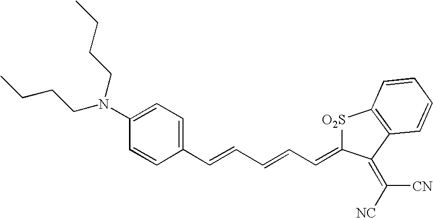

### Example 2

### Preparation of TPD Acrylate/Chromophore Type 10:1 Copolymer by AIBN Radical Initiated Polymerization

The charge transport monomer N-[(meth)acroyloxypropylphenyl]-N,N′,N′-triphenyl-(1,1′-biphenyl)-4,4′-diamine (TPD acrylate) (43.34 g), and the non-linear optical precursor monomer 5-[N-ethyl-N-4-formylphenyl]amino-pentyl acrylate (4.35 g), prepared as described in Example 1, were put into a three-necked flask. After toluene (400 mL) was added and purged by argon gas for 1 hour, azoisobutylnitrile (118 mg) was added into the solution. Then, the solution was heated to 65° C., while continuing to purge with argon gas.

After 18 hrs of polymerization, the polymer solution was diluted with toluene. The polymer was precipitated from the solution and added to methanol, then the resulting polymer precipitate was collected and washed in diethyl ether and methanol. The white polymer powder was collected and dried. The yield of polymer was 66%.

The weight average and number average molecular weights were measured by gel permeation chromatography, using polystyrene standard. The results were Mn=10,600, Mw=17,100, giving a polydispersity of 1.61.

### Example 3

### Preparation of First Photorefractive Composition

A photorefractive composition testing sample was prepared. The components of the composition were as follows:

| | |
|---|---|
| (i) TPD copolymer charge transport (described in Example 2): | 47.3 wt % |
| (ii) NPP chromophore: | 34.8 wt % |
| (iii) N-ethylhexylcarbazole plasticizer: | 15.2 wt % |
| (iv) DBM sensitizer: | 2.7 wt % |

To prepare the composition, the components listed above were dissolved in dichloromethane with stirring and then dripped onto glass plates at 60° C. using a filtered glass syringe. The composites were then cooked at 60° C. for five minutes and then vacuumed for five minutes. The composites were then cooked at 150° C. for five minutes and then vacuumed 30 seconds. The composites were then scrapped and cut into chunks.

Small portions of the chunks were taken off and sandwiched between indium tin oxide (ITO) coated glass plates separated by a 105 μm spacer to form the individual samples.

### Measurement of Diffraction Efficiency

The diffraction efficiency was measured at 980 nm by two beam coupling experiments using a NIR laser. Two beam coupling experiments were done by using two writing beams making an angle of 20.5 degree in air; with the bisector of the writing beams making an angle of 60 degree relative to the sample normal.

Two split p-polarized writing beams with equal intensity of 3 mW, and the beam spot diameter was around 2 mm. So the laser intensity exposed to the sample was around 0.1 W/cm². After applying 5 kv bias to device, energy transfer (two beam coupling) between two p-polarized beams was observed. After 15 min writing, one of the writing beams was blocked. The transmitted signal and the diffracted signal from the other beam were monitored by photodetectors to determine the diffraction efficiency. The grating signal was read out without applying external bias voltage. The Diffraction efficiency (η) was calculated by:

η=I_{diffracted signal}/(I_{diffracted signal}+I_{transmitted signal})

### Measurement of Transmittance

The transmittance of the device was measured by UV-Vis-NIR spectrophotometer. The thickness of the composition was about 105 μm.

### Results

The results of the measurements of the first photorefractive compositions were as follows:

| | |
|---|---|
| Initial diffraction efficiency (%): | 5% |
| Diffraction efficiency (%) after 72 hours: | 5% |
| Transmittance at 980 nm: | 40% |

### Example 4

### Preparation of Second Photorefractive Composition

A photorefractive composition testing sample was prepared. The components of the composition were as follows:

| | |
|---|---|
| (i) TPD copolymer charge transport (described in Example 2): | 47.2 wt % |
| (ii) NPP chromophore: | 17.4 wt % |
| (iii) 7-FDCST chromophore: | 17.7 wt % |
| (iv) N-ethylhexylcarbazole plasticizer: | 14.9 wt % |
| (v) DBM sensitizer: | 2.7 wt % |

### Results

The results of the measurements of the second photorefractive compositions were as follows:

| | |
|---|---|
| Initial diffraction efficiency (%): | 22% |
| Diffraction efficiency (%) after 16 hours: | 10% |
| Transmittance at 980 nm: | 54% |

### Example 5

### Preparation of Third Photorefractive Composition

A photorefractive composition testing sample was prepared. The components of the composition were as follows:

| | |
|---|---|
| (i) TPD copolymer charge transport (described in Example 2): | 46.7 wt % |
| (ii) NPP chromophore: | 25.1 wt % |
| (iii) N-ethylhexylcarbazole plasticizer: | 25.5 wt % |
| (iv) DBM sensitizer: | 2.8 wt % |

### Results

The measurements of the third photorefractive compositions were taken after applying 4 kv bias to the device and 40 minutes of writing. The results were as follows:

| | |
|---|---|
| Initial diffraction efficiency (%): | 53% |
| Diffraction efficiency (%) after 30 hours: | 26% |
| Transmittance at 980 nm: | 46% |

### Comparative Example

A photorefractive composition was obtained in the same manner as in the Example 3, except the components of the composition were different. The components of the comparative composition were as follows:

| | |
|---|---|
| (i) TPD copolymer charge transport (described in Example 2) | 50 wt % |
| (ii) 7-FDCST chromophore: | 30 wt % |
| (iii) N-ethylcarbazole plasticizer: | 20 wt % |

### Results

The measurements of the comparative photorefractive composition were as follows:

| | |
|---|---|
| Initial diffraction efficiency (%): | no signal with/without external bias |
| | voltage |
| Transmittance at 980 nm: | close to 100% |

Each of Example 3-5 exhibited good diffraction efficiency even after several hours and good transmittance at 980 nm. Such NIR sensitivity is important, e.g., because in bio-imaging applications, NIR laser wavelength has better penetration in tissues and skins and can provide more accurate information than other wavelength light. Other applications, such as sensors, dark vision, and telecommunications are frequently preformed using light in the NIR region. As shown in the data for the Comparative Example, which did not contain sensitizer, no grating formation ability was observed upon irradiation with a 980 nm laser because the composition had no absorption in the NIR spectrum. In later testing, the Comparative Example was irradiated with a 532 nm green laser. Only after the irradiation with a green laser was good diffraction efficiency observed in the Comparative Example.

All literature references and patents mentioned herein are hereby incorporated in their entireties. Although the foregoing invention has been described in terms of certain preferred embodiments, other embodiments will become apparent to those of ordinary skill in the art in view of the disclosure herein without departing from the scope of the invention. Accordingly, all such modifications and changes are intended to fall within the scope of the invention, as defined by the appended claims.

What is claimed is:

1. A method for forming a grating in a photorefractive composition, comprising:
providing a photorefractive composition comprising a sensitizer and a polymer, wherein the polymer comprises a first repeating unit which includes a moiety selected from the group consisting of the following formulae (Ia), (Ib), and (Ic): 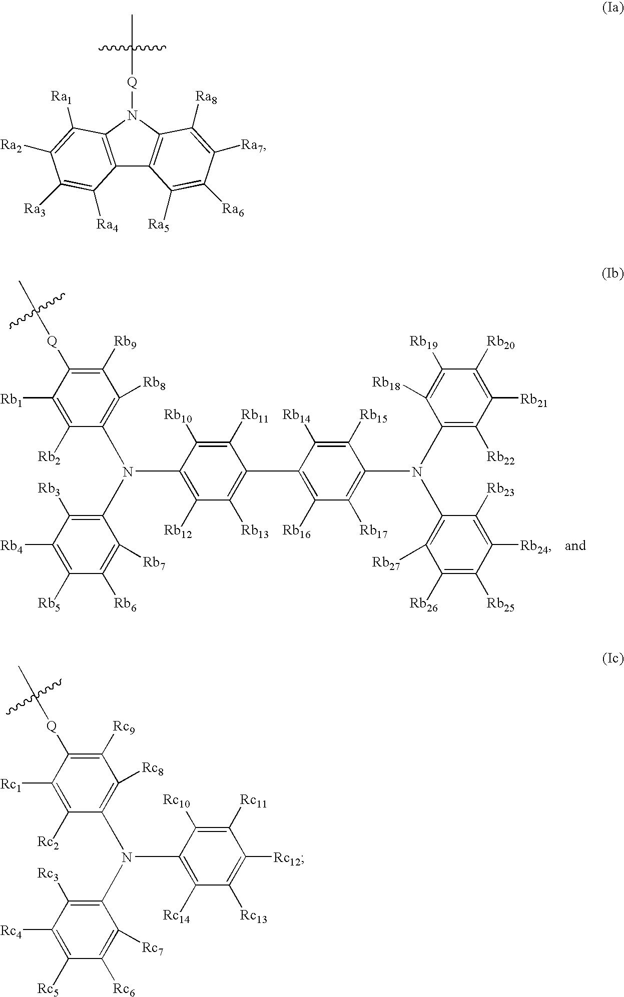
wherein each Q in formulae (Ia), (Ib) and (Ic) independently represents an alkylene or a heteroalkylene; Ra₁-Ra₈, Rb₁-Rb₂₇, and Rc₁-Rc₁₄ in formulae (Ia), (Ib), and (Ic) are each independently selected from the group consisting of hydrogen, linear or branched optionally substituted C₁-C₁₀ alkyl or heteroalkyl, and optionally substituted C₆-C₁₀ aryl; and
irradiating the photorefractive composition with a near infrared (NIR) laser to form a grating, wherein the composition is formulated to provide a grating holding time of about one hour or more upon irradiation by the NIR laser.

2. The method of claim 1, wherein the NIR laser has a wavelength of about 980 nm.

3. The method of claim 1, wherein the photorefractive composition has a transmittance greater than about 30% at a thickness of about 105 μm when irradiated by the NIR laser.

4. The method of claim 1, wherein a grating signal of the photorefractive composition formed by irradiation by the NIR laser can be read out without applying external bias voltage.

5. The method of claim 1, wherein the photorefractive composition further comprises a plasticizer.

6. The method of claim 1, wherein the photorefractive composition further comprises a chromophore.

7. The method of claim 1, wherein the sensitizer comprises a molecule according to formula (V): 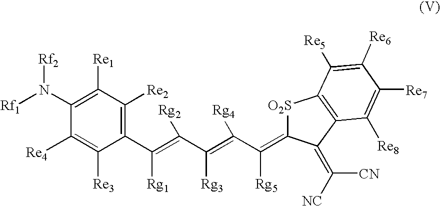
wherein Re₁-Re₈ and Rg₁-Rg₅ in formula (V) are each independently selected from the group consisting of hydrogen, linear or branched C₁-C₁₀ alkyl or heteroalkyl, C₆-C₁₀ aryl, and halogen; and Rf₁ and Rf₂ are each independently selected from the group consisting of hydrogen and linear or branched optionally substituted C₁-C₁₀ alkyl.

8. The method of claim 7, wherein Re₁-Re₈ and Rg₁-Rg₅ are each independently selected from the group consisting of hydrogen and linear or branched C₁-C₄ alkyl or heteroalkyl; and Rf₁ and Rf₂ are each independently selected from the group of linear or branched C₁-C₁₀ alkyl, —CH₂CH₂OH, —CH₂CH₂OCOCH₃, and —CH₂CH₂OSi(CH₃)₂C(CH₃)₃.

9. The method of claim 7, wherein the sensitizer comprises 2-[2-{5-[4-(di-n-butylamino)phenyl]-2,4-pentadienylidene-1,1-dioxido-1-benzothien-3(2H)-ylidene]malononitrile.

10. The method of claim 1, wherein the sensitizer is provided in the composition in an amount in the range of about 0.1% to about 10% based on the weight of the photorefractive composition.

11. The method of claim 1, wherein the sensitizer is provided in the photorefractive composition in an amount in the range of about 0.5% to about 5% based on the weight of the photorefractive composition.

12. A composition configured to be photorefractive upon irradiation by a near infrared (NIR) laser comprising a sensitizer and a polymer, wherein the polymer comprises a first repeating unit which includes at least one moiety selected from the group consisting of the following formulae (Ia), (Ib) and (Ic): 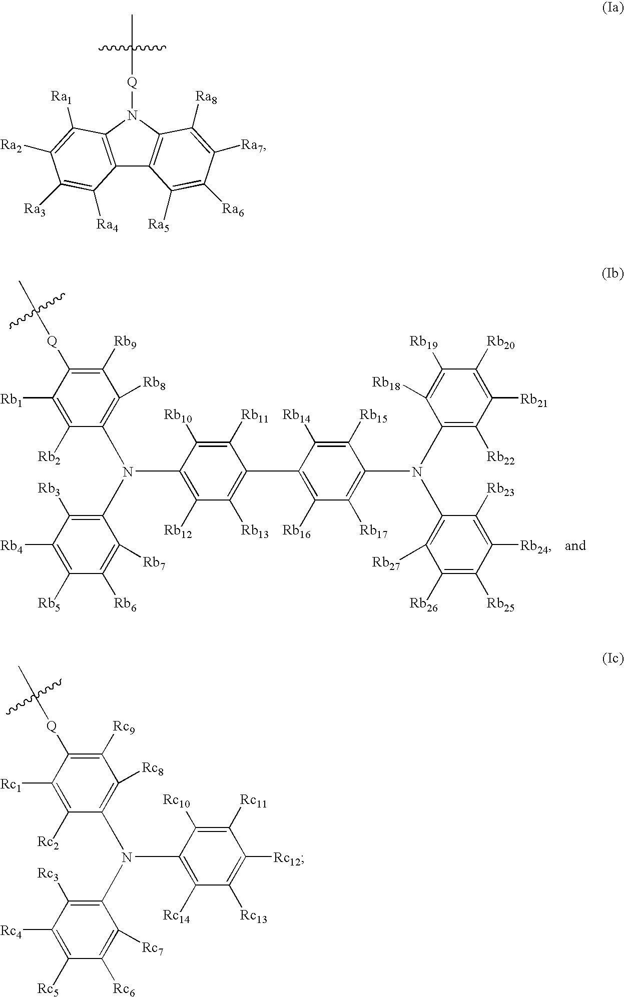
wherein each Q in formulae (Ia), (Ib) and (Ic) independently represents an alkylene group or a heteroalkylene group; Ra₁-Ra₈, Rb₁-Rb₂₇ and Rc₁-Rc₁₄ in formulae (Ia), (Ib), and (Ic) are each independently selected from the group consisting of hydrogen, linear or branched optionally substituted C₁-C₁₀ alkyl or heteroalkyl, and optionally substituted C₆-C₁₀ aryl; and
wherein the composition provides a grating holding time of about one hour or more upon irradiation by the NIR laser.

13. The composition of claim 12, wherein the photorefractive composition is formulated such that a grating that is irradiated into the photorefractive composition can be read out of the photorefractive composition without applying an external bias voltage.

14. The composition of claim 12, wherein the polymer further comprises a second repeating unit which includes a moiety represented by the following formula (IIa): 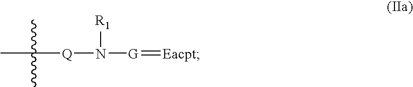
wherein Q in formula (IIa) represents an alkylene group or a heteroalkylene group; R₁ in formula (IIa) is selected from the group consisting of hydrogen, linear C₁-C₁₀ alkyl, branched C₁-C₁₀ alkyl and C₆-C₁₀ aryl; G in formula (IIa) is a π-conjugated group; and Eacpt in formula (IIa) is an electron acceptor group.

15. The composition of claim 14, wherein the second repeating unit is represented by the following formula (IIa′): 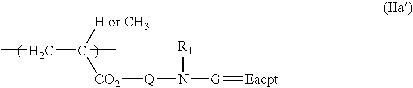
wherein Q in formula (IIa′) represents an alkylene group or a heteroalkylene group; R₁ in formula (IIa′) is selected from the group consisting of hydrogen, linear C₁-C₁₀ alkyl, branched C₁-C₁₀ alkyl, and C₆-C₁₀ aryl; G in formula (IIa′) is a π-conjugated group; and Eacpt in formula (IIa′) is an electron acceptor group.

16. The composition of claim 14, wherein G in formula (IIa) is represented by a structure selected from the group consisting of the following formulae (G-1) and (G-2): 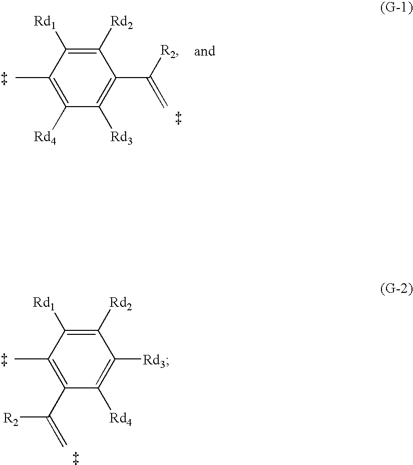
wherein Rd₁-Rd₄ in formulae (G-1) and (G-2) are each independently selected from the group consisting of hydrogen, linear C₁-C₁₀ alkyl, branched C₁-C₁₀ alkyl, C₆-C₁₀ aryl, and halogen; and R₂ in formulae (G-1) and (G-2) is independently selected from the group consisting of hydrogen, linear C₁-C₁₀ alkyl, branched C₁-C₁₀ alkyl, and C₆-C₁₀ aryl.

17. The composition of claim 14, wherein Eacpt in formula (IIa) is represented by oxygen or a structure selected from the group consisting of the following formulae (E-2) to (E-6): 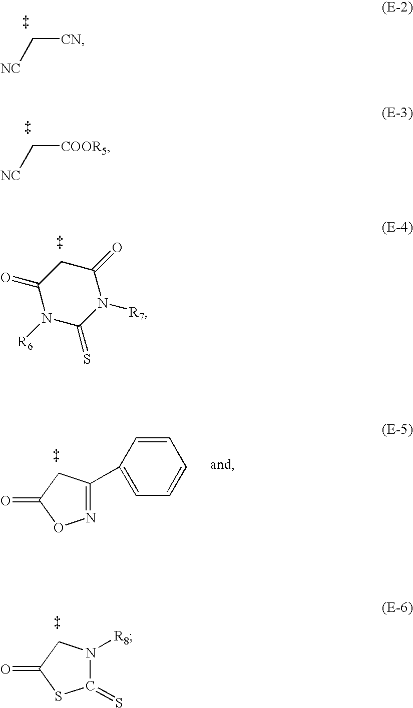
wherein R₅, R₆, R₇ and R₈ in formulae (E-3), (E-4), and (E-6) are each independently selected from the group consisting of hydrogen, linear C₁-C₁₀ alkyl, branched C₁-C₁₀ alkyl, and C₆-C₁₀ aryl.

18. The composition of claim 12, wherein the composition further comprises a plasticizer.

19. The composition of claim 12, wherein the composition further comprises a chromophore.

20. The composition of claim 12, wherein the sensitizer comprises a molecule according to formula (V): 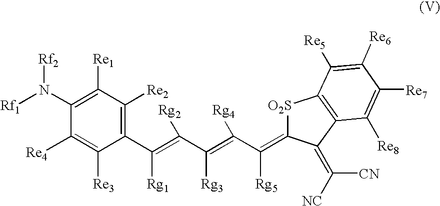
wherein Re₁-Re₈ and Rg₁-Rg₅ in formula (V) are each independently selected from the group consisting of hydrogen, linear or branched C₁-C₁₀ alkyl or heteroalkyl, C₆-C₁₀ aryl, and halogen; and Rf₁ and Rf₂ are each independently selected from the group consisting of hydrogen, linear or branched optionally substituted C₁-C₁₀ alkyl.

21. The composition of claim 20, wherein Re₁-Re₈ and Rg₁-Rg₅ are each independently selected from the group consisting of hydrogen and linear or branched C₁-C₄ alkyl; and Rf₁ and Rf₂ are each independently selected from the group of linear or branched C₁-C₁₀ alkyl, CH₂CH₂OH, CH₂CH₂OCOCH₃, and CH₂CH₂OSi(CH₃)₂C(CH₃)₃.

22. The composition of claim 20, wherein the sensitizer comprises 2-[2-{5-[4-(di-n-butylamino)phenyl]-2,4-pentadienylidene-1,1-dioxido-1-benzothien-3 (2H)-ylidene]malononitrile.

23. The composition of claim 12, wherein the sensitizer is provided in the composition in an amount in the range of about 0.1% to about 10% based on the weight of the composition.

24. The composition of claim 12, wherein the sensitizer is provided in the composition in an amount in the range of about 0.5% to about 5% based on the weight of the composition.

25. The composition of claim 12, wherein the first repeating unit selected from the group consisting of the following formulae (Ia′), (Ib′) and (Ic′): 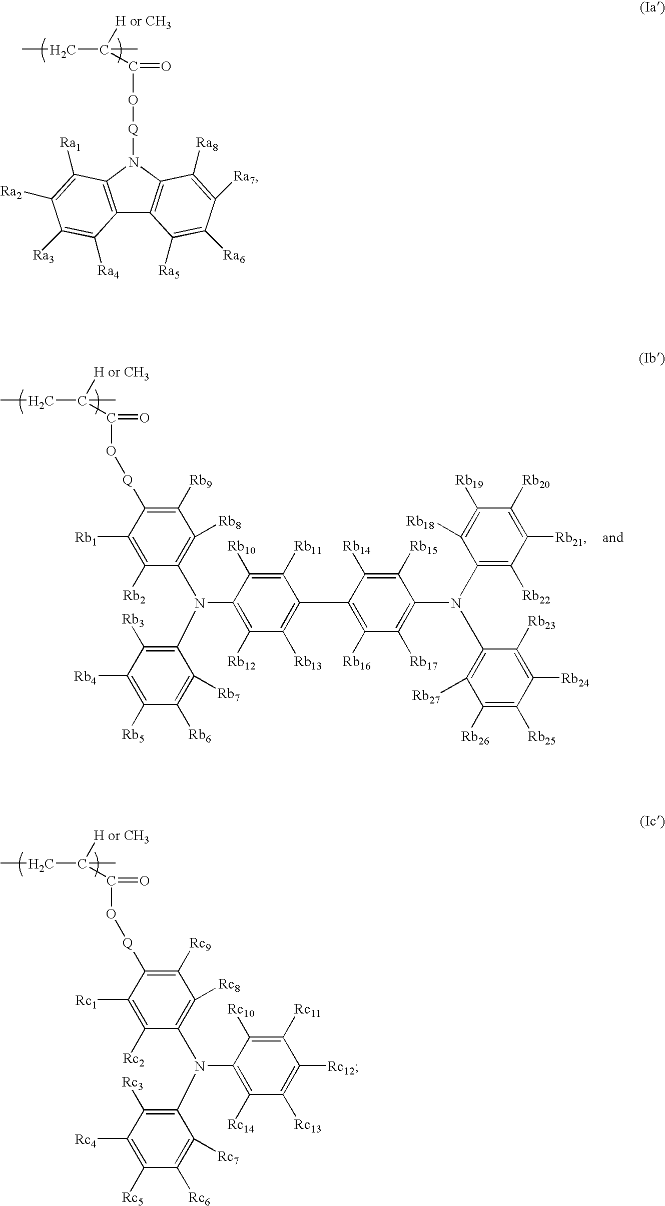
wherein each Q in formulae (Ia′), (Ib′) and (Ic′) independently represents an alkylene group or a heteroalkylene group; Ra₁-Ra₈, Rb₁-Rb₂₇ and Rc₁-Rc₁₄ in formulae (Ia′), (Ib′) and (Ic′) are each independently selected from the group consisting of hydrogen, linear or branched optionally substituted C₁-C₁₀ alkyl or heteroalkyl, and optionally substituted C₆-C₁₀ aryl.

26. The composition of claim 12, wherein the composition has a transmittance greater than about 30% at a thickness of about 105 μm when irradiated by the NIR laser.

27. The composition of claim 12, wherein the composition is configured to be photorefractive upon irradiation by the NIR laser at a wavelength of about 980 nm.

28. An optical device comprising the composition of claim 12.
